(19) United States
(12) Patent Application Publication
(10) Pub. No.: US 2010/0143430 A1
(43) Pub. Date: Jun. 10, 2010

(54) Antimicrobial agents

(76) Inventors: Joseph A. King, Wayzata, MN (US); John Hill, Plymouth, MN (US)

Correspondence Address: Carl L. Johnson;Jacobson and Johnson, Suite 285, One West Water Street, St. Paul, MN, 55107, US

(21) Appl. No.: 12/592,700

(22) Filed: Dec. 1, 2009

Related U.S. Application Data
(60) Provisional application No. 61/201,303, filed on Dec. 8, 2008.

(51) Int. Cl. A01N 25/08; A01N 59/16; A01P 1/00

(52) U.S. Cl. 424/409; 424/618

(57) ABSTRACT

An antimicrobial agent to kill microorganisms by enhancing the concentration of metal ions through use of compound containing a hydantoin ring in the presence of a liquid. The method includes the step of to enhancing the effectiveness of the biocidal component to lessen the need for a supplemental biocide wherein the antimicrobial agent may be in an active state i.e. liquid or an inactive state i.e. solid, tablet, powder, granular form or combinations thereof. The apparatus includes a dispenser containing an antimicrobial agent in either an active state or an inactive state with the antimicrobial agent comprising a compound containing a hydantoin ring and a source of biocidal metals ions for delivery of the antimicrobial agent to a site of microorganisms.

### CROSS REFERENCE TO RELATED APPLICATIONS

This application claims priority from provisional application Serial No. 61/201,303 titled Enhanced Sanitizer filed Dec. 08, 2008.

### FIELD OF THE INVENTION

This invention relates generally to antimicrobial agents and, more specifically to antimicrobial agents containing a source of biocidal metal ions and a compound containing a hydantoin ring with the antimicrobial agent in either an active or an inactive state.

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

One of the concerns for individuals and businesses is the presence of harmful bacteria and toxins in both a home environment and a business environment as well as the need to preserve materials from decay or decomposition. It is known that bacteria and other microorganisms can remain in an active state on structure surfaces for an extended length of time. The presence of a liquid such as water can cause the bacteria and other harmful microorganism to rapidly increase. As a result it becomes more likely that bacteria and other harmful microorganisms can be transferred from individual to individual through physical contact with the structure surfaces carrying the bacteria and other harmful microorganisms. It is also evident that the bacteria and harmful organisms can cause decay and decomposition. It is known that antimicrobial agents, which contain metal ions, can be used to kill unwanted organisms. However, one of the disadvantages of antimicrobial agents that contain metal ions is that the release of metal ions becomes limited by the solubility of the metal ions in the presence of a fluid.

The invention described herein provides antimicrobial agents that can reduce or eliminate harmful bacteria and other harmful microorganisms through releasing higher levels of antimicrobial metal ions from known antimicrobial agents.

### SUMMARY OF THE INVENTION

Briefly, the present invention comprises an antimicrobial agent comprised of a source of biocidal metal ions and a compound containing a hydantoin ring, which may lack antimicrobial properties. The combination of the source of biocidal metal ions and a compound containing a hydantoin ring providing greater antimicrobial properties than if the source of biocidal metal ions were used alone. The antimicrobial agent may be applied in liquid form to a surface to eliminate or prevent growth of harmful microorganisms or by incorporating the antimicrobial agent in a dry state into or onto a surface and then activating the antimicrobial agent by introduction of a liquid to the antimicrobial agent.

### BRIEF DESCRIPTION OF THE DRAWINGS

FIG. 1 shows a powder antimicrobial agent in a dry state;

FIG. 2 shows the powder antimicrobial agent of FIG. 1 being dispensed through a spout of a dispenser container into a body of water;

FIG. 3 shows an enhanced granules or pellets of an antimicrobial agent in a dry state;

FIG. 4 shows the enhanced granules or pellets of the antimicrobial agent of FIG. 3 being dispensed through an orifice located on a dispenser container into a body of water to activate the antimicrobial agent;

FIG. 5 shows an antimicrobial agent in a dry state on a dipstick ;

FIG. 6 shows the antimicrobial agent on a dipstick of FIG. 5 being immersed in an open body of water;

FIG. 7 shows an antimicrobial agent in a liquid state for treating an open body of water;

FIG. 8 shows the antimicrobial agent of FIG. 7 being dispensed through an orifice of a dispenser container into a body of water;

FIG. 9 shows the concentrations of silver with and without the addition of DMH;

FIG. 10 shows an example of a one-chamber dispenser;

FIG. 11 shows an example of a two-chamber dispenser;

FIG. 12 shows the structure of a hydantoin ring.

### DESCRIPTION OF THE PREFERRED EMBODIMENT

The invention described herein comprises an antimicrobial agent which may be applied or used in various forms with the antimicrobial agent providing more effective killing of harmful organisms than normally available from only the source of biocidal metal ions in the antimicrobial agent.

In one example the invention includes an antimicrobial agent for use in killing and controlling microorganism with the microorganism killing material comprising a source of biocidal metal ions to kill microorganisms wherein the level of available biocidal metal ions is limited by the presence of a liquid; and a compound containing a hydantoin ring, wherein the compound containing a hydantoin ring may lack antimicrobial properties but the presence of the liquid with the combination of the compound containing a hydantoin ring and the source of biocidal metal ions generates higher levels of available biocidal metal ions for killing microorganisms than the source of biocidal metal ions without the compound containing the hydantoin ring.

In another example the invention includes a method for antimicrobial treating to kill microorganisms in the presence of water comprising the steps of supplying a microorganism killing material comprising a source of biocidal metal ions and adding a compound containing a hydantoin ring, which may not have antimicrobial properties, to the source of biocidal metal ions to thereby increase an availability of biocidal metal ions to kill microorganisms; and then applying the source of biocidal metal ions and the compound containing a hydantoin ring to a source of harmful microorganisms to thereby kill the harmful microorganisms.

In another example the method of antimicrobial treating may be applied to or incorporated into an object when the source of biocidal metal ions and the compound containing a hydantoin ring are in a dry state by applying an antimicrobial agent including a source of biocidal metal ions in a dry state to the object; applying a compound containing a hydantoin ring in a dry state to the object; and bringing a liquid into contact with the source of biocidal metal ions in a dry state and the compound containing a hydantoin ring in a dry state to thereby generate a level of biocidal metal ions in the liquid that is greater than if the liquid came into contact with only the source of biocidal metal ions

In another example the invention described herein relates to affecting an open water supply to either eliminate or control the growth of microorganism therein. Controlling the growth of a microorganism as used herein is intended to encompass diminished proliferation and/or lethal results to microorganisms including but not limited to bacteria, spores, yeast, fungi, mold and other multi-cellular microorganisms.

For example, a supply of open water is often time exposed to harmful microbial growth. Several types of bacteria and other harmful microorganisms are naturally present in water and breed exponentially through time. Processes have been developed to sanitize open water supplies including the addition of chlorine, either in liquid or pellet form to the open water supply to kill the bacteria and other harmful microorganisms. Such a process has proven effective in controlling the growth of the bacteria and other harmful microorganisms; however, there are drawbacks to such a process. One main drawback is that the use of chlorine potentially corrodes and damages the container housing the water.

Another effective way of eliminating bacteria and other harmful microorganisms, in an open water supply is to use biocidal metals that release heavy metals ions and particularly heavy metals ions such as silver ions into the supply of open water. Although silver ions are effective in killing bacteria and other harmful microorganisms the solubility of the metal ions of the various silver ion donors in water is limited and hence the effectiveness in quickly and effectively killing bacteria and other harmful microorganisms is also limited. In addition, due to the nature of silver ions in readily complexing with other components or compounds, it is often difficult to maintain silver ions in the biocidially active form for long durations.

It has been found, as FIG. 9 shows, that compounds containing a hydantoin ring, which may not have antibacterial properties such as such as 5,5-dimethylhydantoin (DMH), can interact with metal ion donors including silver metal ion donors such as silver bromide to increase the solubility of the silver bromide in a supply of water and aid in the sanitation process. For example, it has been found that with a silver ion donor in the presence of DMH in a liquid such as water, the dissolved silver concentrations are higher than anticipated when compared to a control solution without the presence of DMH even though the DMH lacks antimicrobial properties. In addition, the dissolved silver concentration also increases with time. The results suggested that compounds containing a hydantoin ring interact with silver to form a soluble complex even if the source(s) of silver are from insoluble salts such as silver bromide, which in some cases may be derived from silver chloride. It has also been found that compounds that contain a hydantoin ring which do have antimicrobial properties such as halogenated hydantoins including Bromochlorodimethylhydantoin (BCDMH) Dichlorodimethylhydatoin (DCDMH) also provide for greater availability of metal ions

In the example described herein the effectiveness of the sanitizing metal ions, particularly the silver ions, is enhanced through increasing the solubility of the silver ions by addition of a compound or compounds containing a hydantoin ring in the presence of water.

Silver chloride is a white powder that can be melted or cast like a metal, and is generally derived from heating a silver nitrate solution and adding hydrochloric acid or salt solution to produce a silver chloride solution, which is then boiled or filtered either in the dark or under a ruby red light to produce the silver chloride powder. It is also known that a compound containing a hydantoin ring such as 5,5-dimethylhydantoin (DMH), which has no known antimicrobial properties, may also be obtained in powdered form. FIG. 1 shows an embodiment of an enhanced antimicrobial agent 35 comprising a dispenser container 36 supporting a mixture of DMH-silver chloride 37 in powder or dry form therein. It is noted that in the powder form, the DMH and silver chloride do not interact with each other. However, an interaction between the DMH and silver chloride is initiated once the DMH and silver chloride are in the presence of a fluid such as water.

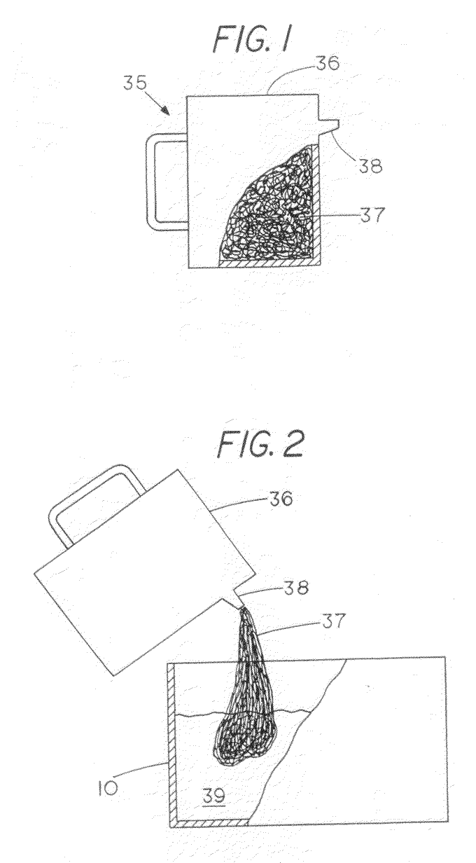

FIG. 2 shows the antimicrobial agent comprising a DMH-silver chloride powder 37 being dispensed through a spout of the dispenser container 36 into a body of water 39 supported by a housing 40, which may for example be a foot bath container which is used to prevent transmission of communicable diseases while receiving a pedicure. As the DMH-silver chloride powder 37 comes into contact with water 39, the silver chloride in the DMH-silver chloride powder 37 releases silver ions into the water 39 to effectively kill or control microorganisms in the water. When used alone the silver has a tendency to complex with other compounds and become increasingly insoluble thereby reducing the effective microorganisms killing ability of the silver. However, it has been found that when silver is used with the DMH, the DMH enhances the biocidal effectiveness of the silver by forming a complex with the silver to allow the silver to remain soluble to a higher degree thereby retaining the silver's antimicrobial activity.

That is, while the silver chloride provides for an effective initial antimicrobial agent, it has been found that the complex between a compound containing a hydantoin ring, such as DMH and the silver in the presence of water also provides for an effective prolonged acting antimicrobial agent. Use of the DMH-silver chloride powder 37 thus will be ideal for a body of water that requires fast acting such as in the soaking stage of a clothes washing machine.

With the antimicrobial agent in liquid form the antimicrobial agent can be placed in a sprayer or spray bottle to allow the enhanced antimicrobial agent to be applied as a coating to a range of objects to protect the coated item from mold, algae or the like. For example items such diverse items such as clothing, medical devices and agricultural products such as seed coatings may be coated with the antimicrobial agent in a carrier to prevent mold and germination problems thereon by either spraying or immersing the seed and allowing the carrier to evaporate. In other applications the products may be coated with the antimicrobial agent in a dry state. In either case when a liquid such as water comes into contact with the antimicrobial agent on product the antimicrobial agent releases the biocidal metal ions to kill harmful organisms thereon.

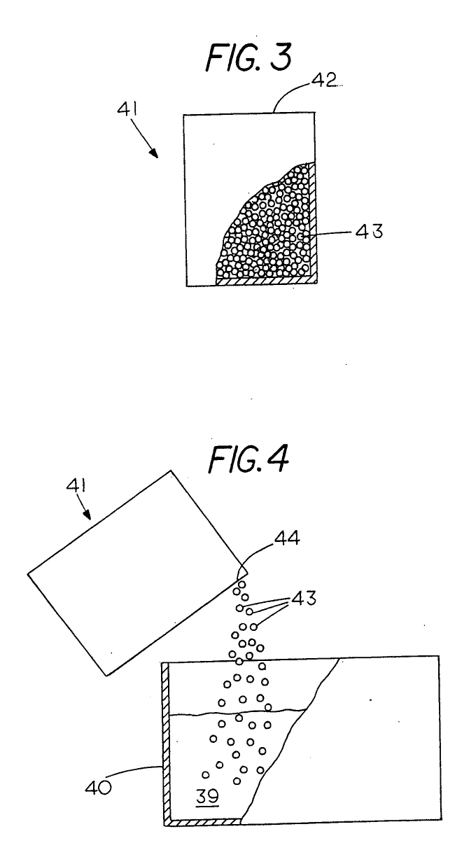

FIG. 3 shows an example of the antimicrobial agent 41 wherein a dispenser container 42 supports DMH-silver chloride granules or pellets 43 therein in a dry state. An example of one of the processes involved in forming the pellets may comprise the combination of the silver chloride while in solution with an adhesive to form an adhesive silver chloride solution. The adhesive and the silver chloride solution may be then applied to a carrier such as a pellet. The pellet may be an active carrier, such as containing the DMH, or a passive carrier, in which the DMH is added to the silver chloride solution as the adhesive is cured to produce a pellet coated with silver chloride particles and DMH particles with both the silver chloride particles and DMH particles available for releasing into the body of water 39 where they are able to complex and aid in the process of killing bacteria and other harmful microorganisms in the body of water 39. A suitable material for adhesively securing the silver chloride proximate the carrier is commercially available gelatin, which can be cross-linked with an aqueous solution of formaldehyde or glutaraldehyde to form a non-soluble, water penetrable matrix on the exterior surface of the carrier. Other suitable non-soluble water porous adhesive matrixes are polyvinyl acetate, polyurethane, epoxy resin, polyvinyl alcohol and polyvinyl acetate.

FIG. 4 shows an antimicrobial agent comprising DMH-silver chloride pellets 43 in a dry state being dispensed through an orifice 44 located on the dispenser container 42 into the body of water 39 supported by housing 40. As the DMH-silver chloride pellets 43 come into contact with the body of water 39, the silver chloride in the DMH-silver chloride pellets 43 releases silver ions into the body of water 39 to effectively kill or control microorganisms. The DMH then enhances the biocidal effectiveness of the silver by forming a complex with the silver to allow the silver to remain soluble to a higher degree thereby retaining the silver's antimicrobial activity.

A feature of DMH-silver chloride pellets 43 is that unlike the DMH-silver chloride powder 37 of FIGS. 1 and 2, the DMH-silver chloride pellets 43 releases the silver chloride and the DMH at a slower rate for more of a time-controlled release. That is, the silver chloride and the DMH located inside or located in the inner layer of the DMH-silver chloride pellets 43 are not release, i.e. dissolved in the body of water, until the silver chloride and DMH located on the outer layer of the DMH-silver chloride pellets 43 are released into the body of water 39. Use of the DMH-silver chloride pellets 43 thus will be ideal for an open body of water such as in a pool, spa, or hot tub in which the same body of water is intended to be use repeatedly.

FIG. 5 shows an enhanced sanitizing dipstick 45 comprising a DMH-silver chloride pad 47 in a dry state having a handle 46a extending therefrom. The enhanced sanitizing dipstick 45 may be formed similar to the DMH-silver chloride pellets 43 of FIGS. 3 and 4, namely by the combination of the silver chloride while in solution with an adhesive to form an adhesive silver chloride solution. The adhesive and the silver chloride solution are then applied to an end of a stick 46 and allowed to dry. The DMH may then be added to the silver chloride solution as the adhesive is cured to produce a DMH-silver chloride pad or puck 47 in a dry state comprising silver chloride particles and DMH particles with both the silver chloride particles and DMH particles activateable in the body of water 39 where they are able to complex and aid in the disinfection process of the body of water 39.

The cross-sections for the enhanced sanitizing dipstick 45 may be of any choice, e.g. square, rectangular, oval, hexagonal, irregular, etc. The DMH-silver chloride pad or puck 47 is utilized to dispense the silver chloride and DMH into a body of water or a water source. Once exhausted, the enhanced sanitizing dipstick 45 may be disposed of simply by discarding the stick 46.

FIG. 6 shows the sanitizing dipstick 45 being used in housing 40 with at least a portion of the DMH-silver chloride pad 47 submerged in the body of water 39 to dispense the DMH and silver chloride into body of water 39.

Since the antimicrobial agent wherein a DMH-silver chloride pad 47 is thicker than the DMH-silver chloride pellets 43 of FIGS. 3 and 4, the DMH-silver chloride pad 47 releases silver chloride and DMH at a slower rate then the DMH-silver chloride powder 37 of FIGS. 1 and 2 and the DMH-silver chloride pellets 43 of FIGS. 3 and 4. That is, the silver chloride and the DMH located inside or located in the inner layer of the DMH-silver chloride pad 47 are not released, i.e. dissolved in the body of water, until the silver chloride and DMH located on the outer layer of the DMH-silver chloride pellets 43 are released into the body of water 39. Use of the dipstick 45 with the antimicrobial agent in a dry state and in tablet or puck form will be ideal for an open body of water that requires lengthy or extended release of antimicrobial agents but not immediate releases of antimicrobial agents such as in the container of humidifiers and dehumidifiers.

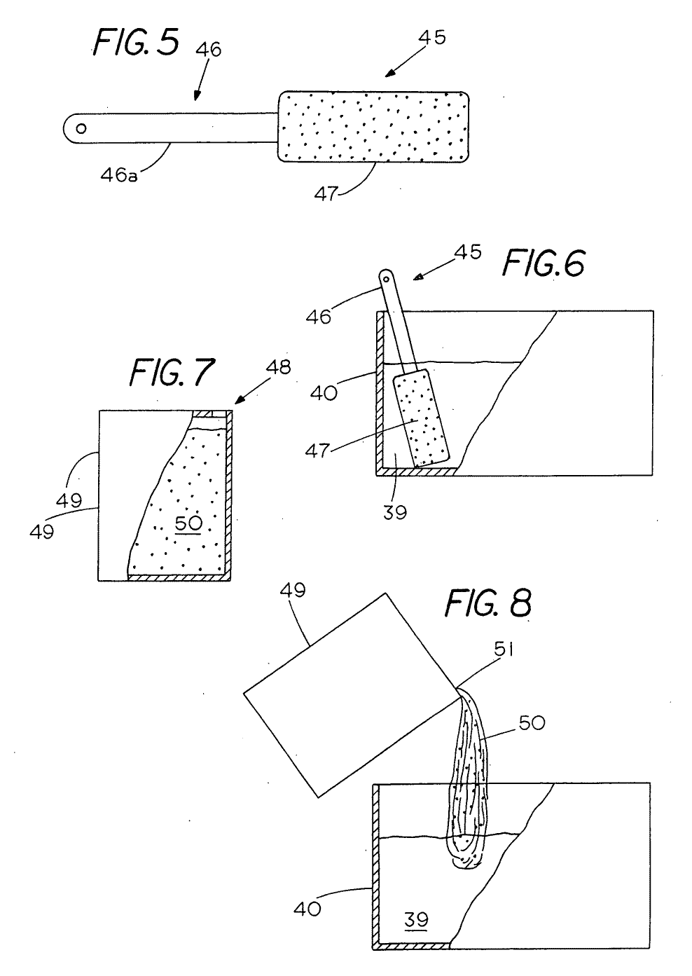

FIG. 7 shows an antimicrobial agent dispenser 48 comprising a housing or container 49 supporting a DMH-silver chloride solution 50 therein. Unlike the DMH-silver chloride powder 37, the DMH-silver chloride pellets 43, and DMH-silver chloride dipstick 45, which all dispenses silver chloride particles and DMH particles in a dry state into the body of water 39, the enhanced antimicrobial agent 48 does not dispense silver chloride particles and DMH particles into the body of water 39 in a dry or inactive state. Instead, FIG. 8 shows the antimicrobial agent 48 comprising the biocidal DMH-silver complex in a liquid or active state being dispensed into a container 40. That is, the dispenser container 49 contains a liquid containing silver chloride particles and DMH particles. The DMH interacts with the silver to form a soluble complex that is effective in killing microbial. As the DMH is maintained in the liquid with the silver, the DMH continuously interacts with the silver thereby increasing the concentration microbial killing soluble silver complex until the either the DMH or silver chloride particles are exhausted or until the fluid is saturated with the microbial killing soluble silver complex.

FIG. 8 shows the antimicrobial agent comprising a DMH-silver chloride solution 50 in an active state being dispensed through an orifice 51 of the dispenser 49 into the body of water 39 supported by housing 40. Use of the DMH-silver chloride solution 50 in an active state thus will be ideal for an open body of water that requires immediate sanitation such as an open body of water that needs to be sanitized for human consumption, for use as hard surface disinfectant, or for use as a body disinfectant.

It is noted that the DMH-silver chloride solution 50 (i.e. the resultant complex formed by an interaction between the DMH and the silver ion donor such as silver chloride) may also be used as a spray applied as a liquid stream, fine vapor, mist, small drops, aerosol, or non-aerosol. This spray can then be used to expose a microorganism to DMH-silver complex in liquid form. The spray could be used for example to control the growth of microorganisms in or on clothing and various hard surfaces. The sprayable DMH-silver chloride complex may, optionally, include additional additives such as, e.g., a fragrance, water thickener, surfactant, dispersant, supplemental solvents, anti-static agent, colorant, etc.

In further regards to the present invention, the powder, granules, tablets/dipstick, and liquid produced from the silver chloride and DMH either in particulate or complex forms are of particular utility as biocidal agents for use in other environments that may not have been previously mentioned such as industrial as well as medical and home use applications including but not limited to elements of protective coatings such as paints, hand wash formulations, in ointments and related topical applications, cosmetics, cleaning and/or disinfectant/sanitation products, toilet bowl cleaners, cooling towers, liquid paint, air washer systems, wastewater, pulp and paper processing operations, oil field applications, and decorative fountains and sanitation of recreational water such as swimming pools and spas. The DMH-silver chloride complex is also intended to be used as a component in coating fibers and filters.

If desired, the silver chloride and DMH and/or the DMH-silver complex can be formulated with suitable additives such as but not limited to binders, lubricants, disintegrants, and mold release agents. Other optional ingredients which may be used in the formation of a resultant product include fragrances, stabilizers, coloring agents, corrosion inhibitors, dyes, viscosity modifying agents, other biological agents, surfactants, effervescent, diluents, antifoaming agents, enzymes, anti-spotting agents, anti-oxidants, preservatives, and anti-corrosion agents, builders, chelating agents, and the like.

In order to verify that a compound containing a hydantoin ring, such as DMH, which has no known antimicrobial properties, interacts to increase the solubility of extremely insoluble silver, a test was performed using either silver chloride or silver bromide as the donor of metal ions in order to demonstrate the increase of silver concentration in a body of water when DMH is used in combination with the source of metal ions.

FIG. 12 shows a schematic of the structure of a hydantoin ring with carbon and nitrogen atoms joined in a five-sided ring. An oxygen atom is attached to two of the carbons in the hydantoin ring. The lines extending from the third carbon atom and the nitrogen atom indicate that other atoms could be attached thereto. For example, in a compound containing a hydantoin ring, such as DMH (5,5-dimethylhydantoin), two methyl groups would be attached to the carbon atom an a hydrogen atom would be attached to each of the two nitrogen atoms.

It has been found that a compound containing a hydantoin ring such as 5,5-dimethylhydantoin (DMH), which lacks antimicrobial properties, has the ability to interact with a source of metal ions to increase the solubility of the silver in a water environment and enhance the antimicrobial process. It has also been found that compounds containing a hydantoin ring which have antimicrobial properties such as Bromochlorodimethylhydantoin (BCDMH) and Dichlorodimethylhydatoin (DCDMH) also interact to increase the solubility of silver in the presence of water. While a number of compounds with a hydantoin ring may be used as a practical matter one may want to avoid those compounds where the group or groups on the compound may have an adverse effect on the sanitized product.

Examples of other well known compounds wherein the compound contains a hydantoin ring include silverdimethylhydantoin 1-hydroxymethyl-5,5-dimethlyl hydantoin, glycolyurea and Copper hydantoin, Hydantoin-5-acetic acid, and Imidazolidines including parabanic acid, 2-Thiohydantoin, hydantoin purum, hydantoin, 1-Aminohydantoin hydrochloride,2-Imidazolidone, 2-Imidazolidone purum, 2-Imidazolidinethione, 2-hydrazino-2-imidazoline hydrobromide, 2-oxo-1-imidazolidinecarbonyl chloride, 1-methyl hydantoin, 5-methylhydandtoin, 2-imidazolidone-4-carboxylic acid, allantoin, allantoin purum, creatinine anhydrous, creatinine biochemika, creatinine hydrochloride, 2-methyl-2-imidazoline, 2-methylithio-2-imdazoline hydrodide, 3-brmo-1-chlor-5-5-dimethlyhydantoin, 1-3-dibromo-5,5-dimethlyhydantoin purium, 1-3-dichlorol-5,5-dimethylhydantoin, 1,3-dichlor-5,5-dimethylhydantoin, hydantoin-5-acetic acid. 2-chlorocarbonyl-1-methanesulfonyl-2imidaz olidinone. 5,5-dimethylhydantoin purum. 5,5-dimethylhydantoin, 2-imino-1-imidaolidineacetic acid, 1,3-dimethyl-2-imidazolidinone puriss, 1,3-dimethly-2-imidazolidinone purum, 1,3-dimethyl-2-imidazolidinone, 1-(2-hydroxyethyl)-2-imdazolinone, 1,5,5-trimethlylhydantoin, 5-ethyl-5-methylhydantoin, 2-phenyl-2-imidazoline purum, 2-(4,5-dihydro-lh-imidazoyl)-2-phenol, 4-(4,5-dihydro-1H-imidazol-2yl)phenylamine, 5-methyl-5-phentylhydantoin, 2-benzylimidazoline, 4-(4-methyl-4,5-dihydro-1H-imidazol-2-yl)phenyl, Imidazolidinyl urea, 4-hydroxymephenytoin, triethoxy-3-(2-imidazolin-1-yl)propysiliane purum, 1,(p-tosyl)-3,4,4-trimethylimidazolidine, naphazoline nitrate purisss, 5,5,diphenyl-2-thiohydantoin, 5-(4-hydroxyphenyl)-50phenylhydantion, 5-(p-methylphenyl)-5-phenyhydantoin, 1,3,bisbensyl-2-oxoimidazoline-4,5-dicarboxylic acid. Other examples of hydantoins are listed in European patent EP0780125 which is herby incorporated by reference. The above list compounds with a hydantoin ring is illustrative and no limitation thereto is intended.

A silver ion donor in the presence of a compound containing a hydantoin ring such as

DMH has a level of free silver higher than anticipated when compared to the silver ion donor in a water environment without the DMH. The results suggest that DMH enhances the solubility of the silver thereby increasing the biocidal effectiveness.

In order to verify that a compound containing a hydantoin ring, such as DMH, interacts to increase the solubility of insoluble silver in a water environment, a test was performed using either silver chloride or silver bromide as the donor of silver metal ions. The test demonstrated the enhancement of silver in a water environment when DMH is used in combination with a source of silver ions.

### EXAMPLE

Silver bromide was initially prepared from a saturated sodium bromide solution, combined with silver nitrate in solution. The yellow precipitate, silver bromide, was than purified by filtration and washing. Additionally, the solid was allowed to dry before use.

A buffer system having a pH of 7.41 was prepared by adding Fisherbrand® potassium phosphate monobasic-sodium phosphate dibasic buffer to 2 Erlenmeyer flasks filled with 1000 mL of purified water. The first flask was treated with 1.12 grams of 5,5-dimethylhydantoin (DMH) and marked solution “C” (with DMH) and the second flask was left untreated and marked solution “D” (without DMH) for control. In regards to the 5,5-dimethylhydantoin (DMH), the 5,5-dimethylhydantoin (DMH) comprised 97% reagent grade was obtained from Aldrich ® (CAS No. 77-71-4, Cat. No. D161403-1KG).

After the initial set-up, approximately 0.10 grams of dried silver bromide was introduced into a dialysis tubing (Fisherbrand®, 45 mm, MWCO 12,000-14,000) along with purified water. The ends of the dialysis tubing were clamped to contain the silver bromide and purified water. Next, the outside of the dialysis tubing was rinsed several times to ensure that silver bromide residue was not on the outside of the dialysis tubing. A string was then tied to one clamp, and one tube was introduced into each flask. A magnetic stir bar was used to mix the solutions.

During the period of the test, a 100 ml sample were removed from solution “D” (without DMH) and solution “C” (with DMH) at weekly intervals and analyzed for their pH using Orin Perphect Meter 370 and analyzed for their silver ion concentrations using atomic absorption spectrometry.

FIG. 9 shows a table containing a list of the dissolved silver concentration, in parts per billion (ppb) obtained from the 100 ml samples for solution “D” (without DMH) and solution “C” (with DMH) at each of their respective weekly time intervals. The average concentration of dissolved silver for solution “C” (with DMH) was 86 ppb while solution “D” (without DMH) had an average concentration of dissolved silver of 4.7 ppb.

A week after the start date, the concentration of dissolved silver for solution D (without DMH) was at 4.3 ppb, while the concentration of dissolved silver for solution C (with DMH) was at 2.8 ppb. By the end of the testing, 6 weeks later, the concentration of dissolved silver for solution C (with DMH) had increase to 220 ppb, while the concentration of dissolved silver for solution D (without DMH) was 7.1 ppb. That is, by the end of the 6 weeks test, the concentration of dissolved silver was at least 30-fold greater in solution C (with DMH) then for solution D, (without DMH).

In summary, the results of the above testing confirmed that in a solution containing silver bromide, the presence of compound containing a hydantoin ring, such as DMH, leads to a higher dissolved silver concentrations than compared to a control solution containing silver bromide without the presence of the DMH. These results suggest that compounds containing a hydantoin ring interact with silver to form a soluble complex even if the source of silver comprises an extremely insoluble silver salt such as silver bromide.

In regards to generating a level of silver ions, the King Technology, Inc. Frog® Mineral Cartridge provides one method of delivering silver ions in the form of solid silver chloride (AgCl) distributed over a porous matrix. The water releases the soluble silver ions into the water environment with. DMH resulting in the formation of ionic-hydantoin structures. It would be anticipated that soluble silver ions would be depleted from the water environment through the formation of silver bromide, an insoluble salt. However, as shown in FIG. 2 after the DMH was added to the water environment, the actual silver concentrations were higher than the calculated theoretical silver concentration.

It is noted that various insoluble or slightly soluble transition metal salts may also be used in the present invention as a source of silver ions. Examples of insoluble or slightly soluble transition metal salts suitable for use in the present invention include, but are not limited to, AgCl, AgBr, Agl, Ag₂S, Ag₃PO₄, NaAg₂PO₄, CuS, and NaCuPO₄. Other examples of silver compounds include, but are not limited to, AgNO₃, Ag₂CO₃, AgOAc, Ag₂SO₄, Ag₂O, [Ag(NH₃)₂]Cl, [Ag(NH₃)₂]Br, [Ag(NH₃)₂]I, [Ag(NH₃)₂]NO₃, |Ag(NH₃)₂|₂SO₄, silver acetoacetate a silver benzoate, a silver carboxylate, silver amine complexes such as [Ag(NR₃)₂]X, where R is an alkyl or aryl group or substituted alkyl or aryl group and X is an anion such as, but not limited to, Cl⁻, Br⁻, I⁻, OAc⁻, NO₃⁻and SO₄²⁻.

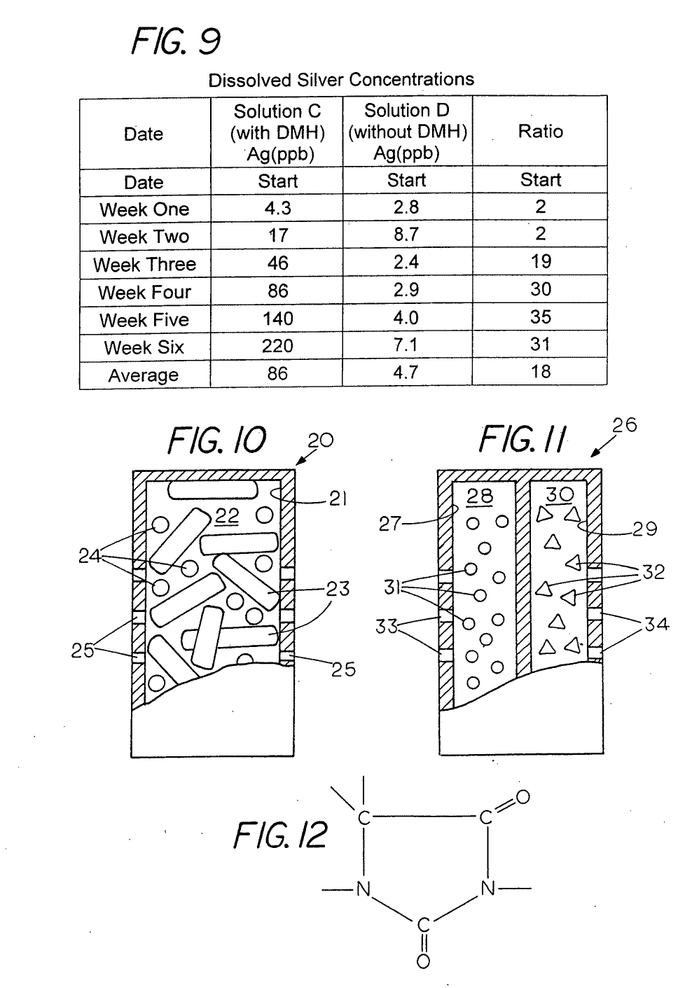

FIG. 10 shows an immersion dispenser 20 having a housing 21 containing a compartment 22 therein. Located in compartment 22 is a source of a compound containing a hydantoin ring such as DMH 23 and a biocidal component such as a source of biocidal metal for generating biocidal metal ions into the body of water. Although various types of biocidal metal such as zinc or copper may be use, in the example shown the biocidal metal used comprises silver, silver alloy or some combination thereof, because of the recognized bactericidal, viricidal, and algaecidal properties of silver ions. The biocidal metals can be introduced as metallic, zero valence material, or as metal ions that can be introduced into the water by dissolution of soluble metal salts, or by the dissolution of the metal itself. For example, silver ion can be introduced into the water through the dissolution of silver nitrate, or through the dissolution of metallic silver as the result of conversion to silver oxide and subsequent conversion of the oxide to more soluble silver species. Mixtures of different salts, or of salts with metallic material, may be combined together to provide the necessary concentration of metal ions in the water. In the embodiment of FIG. 10, the biocidal metal comprises metallic silver 24. A set of openings 25 allows water access to compartment 22 and to the source of DMH 23 and the metallic silver 24.

FIG. 11 shows another dispenser 26 having a first housing 27 containing a compartment 28 and a second housing 29 with a compartment 30 therein. Located in compartment 28 is a silver ion donor such as silver chloride 31 and located in compartment 30 is a source of DMH 32. A set of openings 33 allows water access to compartment 28 and to the silver chloride 31. Similarly, a set of openings 34 allows water access to compartment 30 and the source of DMH 32. In both the embodiment of FIG. 10 and FIG. 11 the antimicrobial agent in the dispenser can be in an active state in the container and then can be activated by placing the dispenser in a body of water.

Although the use of the silver ion donor such as silver, silver oxide, silver salt, or a combination thereof have been disclosed, various types of silver alloys may also be used. The silver may be used standing along in its pure/elemental or alloyed form or coated or impregnated to a substrate and placed in compartment 28. In addition, other types of silver ion donors, other types of transition metals, transition metal oxides, or a combination thereof, and other alternative bactericides whose solubility can be changed in the presence of a compound containing a hydantoin ring can also be used in the present invention.

In regards to the source of DMH 23, 32 of FIGS. 10 and 11, note that FIG. 10 shows source of DMH 22 in particle form with the aforementioned particles having an initial size that is larger than the size of opening 23 to prevent the DMH particles from escaping through opening 23. FIG. 10 shows source of DMH 23 in tablet form. In regards to the DMH tablets, it is noted that various types of material, including but not limited to microcrystalline cellulose (MCC), may be used as a binder in the formation of the DMH tablets which are tabletized with the metal ion donor so that both the DMH and the metal ion donor can be placed in the body of fluid to be treated.

It is also noted that the preferred level of the DMH present in the body of water to be sanitized is between 5 and 25 ppm with the DMH and the source of silver cooperating to maintain a level of silver ions present in the amount of 1 to 3 ppb and/or alternatively cooperating to maintain a level of silver ions present to sustain a standard plate count at 35 degrees F. of less than 200 colonies per milliliter.

In one example the invention may includes the step of placing a dispenser 20, 26 containing both the source of DMH 23, 32 and the metallic silver 24, 31 in the open body of water and allowing water to come into contact with the source of DMH 33, 32 and the metallic silver 24, 31 to periodically release DMH and silver ions into the open body of water. As the DMH is released into the open body of water, the DMH is carried to the metallic silver 24, 31 and interacts with the metallic silver 24, 31 to increase the solubility of the silver ion donors to allow for the release of more silver ions into the open body of water than if the only the metallic silver 24, 31 was present in the open body of water.

We claim:

1. An antimicrobial agent for use in killing microorganisms comprising:
a microorganism killing material comprising a source of biocidal metal ions wherein the level of available biocidal metal ions to kill microorganisms is limited by the presence of a liquid; and
a compound containing a hydantoin ring, wherein the compound containing a hydantoin ring may lack antimicrobial properties but the presence of the liquid with the combination of the compound containing a hydantoin ring and the source of biocidal metal ions generates a higher level of available biocidal metal ions to killing microorganisms than the source of biocidal metal ions without the compound containing the hydantoin ring.

2. The antimicrobial agent of claim 1 wherein the source of biocidal metal ions comprises a metallic silver, silver chloride or a metallic silver alloy.

3. The antimicrobial agent of claim 1 wherein the source of biocidal metal ions and the compound containing a hydantoin ring are in a dry state in either powder, pellet or granular form and the compound containing the hydantoin ring lacks antimicrobial properties.

4. The antimicrobial agent of claim 1 wherein the compound containing a hydantoin ring comprises 5,5-dimethylhydantoin (DMH) and the liquid is water.

5. The antimicrobial agent of claim 1 including:
a carrier having an exterior surface;
a water penetrable matrix on the exterior surface of said carrier wherein the microorganism killing material comprising a source of biocidal metal is dispersed within said water penetrable matrix.

6. The antimicrobial agent of claim 1 wherein the compound containing a hydantoin ring comprises either bromochlorodimethylhydantoin (BCDMH) dichlorodimethylhydatoin (DCDMH) or silverdimethylhydantoin (AgDMH)

7. The antimicrobial agent of claim 1 wherein the antimicrobial agent is in a dry state and is carried by either a stick having a handle or a puck containing the antimicrobial agent,

8. A method for antimicrobial treating to kill microorganisms in the presence of water comprising the steps of:
in the presence of water supplying a microorganism killing material comprising a source of biocidal metal ions;
in the presence of water adding a compound containing a hydantoin ring, which may not have antimicrobial properties, to the source of biocidal metal ions to thereby increase an availability of biocidal metal ions to kill microorganisms; and
applying the source of biocidal metal ions and the compound containing a hydantoin ring to a source of harmful microorganisms to thereby kill the harmful microorganisms.

9. The method of antimicrobial treating in the presence of water of claim 8 including the step of adding a biocidal metal includes adding a transition metal, a transition metal oxide, a transition metal salt, silver, silver oxide, silver salt, or a combination thereof to in the presence of water

10. The method of antimicrobial treating in presence of water of claim 9 wherein the step of adding the compound containing a hydantoin ring comprises adding a halogenated hydantoin selected from the group consisting of Bromochlorodimethylhydantoin (BCDMH), Dichlorodimethylhydatoin (DCDMH), Dibromodimethylhydantoin (DBDMH) or an unhalogeneated hydantoin comprising 5,5-dimethylhydantoin (DMH).

11. The method of treating in presence of water of claim 8 wherein the step of adding a compound containing a hydantoin ring includes dispensing sufficient 5,5-dimethylhydantoin into bring the level of 5,5-dimethylhydantoin to at least 5 ppm.

12. An antimicrobial dispenser comprising:
a housing having a compartment therein;
a source of biocidal metal ions for generating a first level of biocidal metal ions in a liquid and a compound containing a hydantoin ring located in the housing, wherein the compound containing a hydantoin ring may lack antimicrobial properties but the presence of the compound containing the hydantoin ring together with the source of biocidal metal ions generates a second level of available of biocidal metal ions which the second level of available biocidal metal ions greater than the first level of biocidal metal ions when the source of biocidal metal ions and the compound containing the hydantoin ring are in the presence of the liquid.

13. The antimicrobial dispenser of claim 12 wherein the source of biocidal metal ions comprises silver chloride.

14. The antimicrobial dispenser of claim 13 wherein the compound containing the hydantoin ring is either 5,5-dimethylhydantoin comprises a 5,5-dimethylhydantoin (DMH), bromochlorodimethylhydantoin (BCDMH) or dichlorodimethylhydatoin (DCDMH) in either powder, pellet, tablet or granular form.

15. The antimicrobial dispenser of claim 12 wherein the source of biocidal metal ions comprises a silver chloride, metallic silver alloy, pure silver or a substrate coated or impregnated with metallic silver or combinations thereof.

16. The antimicrobial dispenser of claim 12 wherein the compound containing the hydantoin ring comprises 5,5-dimethylhydantoin.

17. The method of claim 11 wherein the method of treatment in the presence of water comprises dispensing the antimicrobial agent into a footbath container.

18. The method of antimicrobial treating of an object to kill microorganisms that may come in contact with the object by:
applying an antimicrobial agent including a source of biocidal metal ions in a dry state to the object;
applying a compound containing a hydantoin ring in a dry state to the object; and
bringing a liquid into contact with the source of biocidal metal ions in a dry state and the compound containing a hydantoin ring in a dry state to thereby generate a level of biocidal metal ions in the liquid that is greater than if the liquid came into contact with only the source of biocidal metal ions

19. The method of claim 18 wherein the antimicrobial treating of an object comprises applying the antimicrobial agent to medical devices and agricultural products.

20. The method of claim 18 wherein the step of bringing the liquid into contact with the source of biocidal metal ions in a dry state and the compound containing a hydantoin ring in a dry state comprises bringing water into the contact with the source of biocidal metal ions and the source of biocidal metal ions comprises silver chloride and the compound containing a hydantoin ring comprises 5,5-dimethylhydantoin.
